(19) United States
(12) Patent Application Publication
(10) Pub. No.: US 2009/0071556 A1
(43) Pub. Date: Mar. 19, 2009

(54) Gaseous fluid mixing apparatus

(76) Inventors: Remi Bourlart, Montrichard (FR); Regine Weber-Rozenbaum, Chateauneuf Sur Loire (FR)

Correspondence Address: JACOBSON HOLMAN PLLC, 400 SEVENTH STREET N.W., SUITE 600, WASHINGTON, DC, 20004, US

(21) Appl. No.: 12/219,687

(22) Filed: Jul. 25, 2008

(30) Foreign Application Priority Data
Aug. 3, 2007 (FR) 07/ 05705

(51) Int. Cl. F16K 11/00

(52) U.S. Cl. 137/597

(57) ABSTRACT

A mixing device for gaseous fluids such as air, made up of a tank having a central line and provided with inlet ducts and outlet ducts arranged so as to create an upward swirling movement of the said fluid inside the said tank in order to ensure homogenous temperature at the outlet, characterised in that the said tank comprises at least one means for amplifying fluid mixing that takes the form of at least one additional communication means with the outside/inside of the said tank. More precisely, the said additional communication means takes the form of at least one draining means defining an open or closed volume, placed on the lower part of the tank, further comprising at least one adjustable shutting means.

This invention relates to a gaseous fluid mixing device applicable to the areas of aeronautics and/or land transport and/or physics.

More particularly, this invention is intended to provide a low-pressure air mixing and distribution system for aircraft.

Generally, a mixing apparatus is made up of a mixing tank with four inlets in the lower part and several outlets in the upper part, in relation to its central line.

This type of mixing apparatus is used to mix flows of hot air, for example from the cabin of the aircraft, with flows of cold air taken from outside the aircraft and then conditioned in respect of pressure and temperature, for example, in order to obtain homogenous ambient temperature air flows inside the cabin for air-conditioning, so as to provide a certain level of comfort inside the said aircraft.

More precisely, the air flow inlets of such devices are generally tangential to the wall of the tank in order to generate a swirling movement of the fluid inside the tank.

Mixing apparatuses are required to meet some specific and indispensable technical characteristics, such as the homogenous distribution of the temperature of the air delivered from its different outlets, minimum fluid head loss and low noise.

Further, the mixing apparatus must be able to maintain the working of its essential characteristics in the event of a failure of a fan located at the inlets and/or outlets or if one of its outlets is obstructed.

U.S. Pat. No. 4,517,813 relates to an aircraft cabin air conditioning system with an air mixing apparatus providing accelerated heat mixing of air flows and allowing the recovery of the water condensates and/or ice particles created due to the contact between hot and cold air flows.

European patent EP 0808273 discloses a system for feeding dehumidified air intended for aircraft cabin air conditioning comprising an air mixing apparatus, with a water separator, and an environmental control system to supply such air. The system includes hot air duct means arranged to make the warmer used air from the cabin, initially loaded with humidity, flow towards a mixing chamber, cold air duct means to make the conditioned air flow to the same mixing chamber, collection means to collect and remove the humidity from the chamber, manifold means to direct the dehumidified joined airstreams onto the cabin.

European patent EP 1188666 shows an aircraft air conditioning system and method that may be adapted to use in pressurized or unpressurized areas, defining a sealed partition between them. More specifically, the air-conditioning system has an aerodynamic shutoff valve and a mixing apparatus designed to swirl the air flow.

The drawbacks of current systems are related firstly to the flow regime inside the tank and secondly to their size.

That is because the known devices are bulky, sometimes noisy, and because of their geometric shape and the involved flow regimes, they lead to non negligible head loss, making it necessary to oversize the supply fans.

The device according to the invention eliminates the drawbacks of the prior art by offering a reduced size, at the same time ensuring high comfort for passengers and crew on board an aircraft, for example. The device according to the invention allows the optimisation of the air, temperature and acoustic performance of the low-pressure mixing chambers.

This invention is aimed at remedying the drawbacks mentioned above, and to that end, it consists in a device for mixing gaseous fluids such as air, comprising a tank with a central line and having inlet and outlet ducts arranged so as to create an upward swirling movement of the said fluid inside the tank in order to ensure homogenous temperature at the outlet, characterised in that the said tank has at least one means for amplifying the mixing of fluid.

More precisely, the said at least one amplifying means is placed on the lower part of the tank. In the description below, the words “lower” and “upper” are used as adjectives to qualify the parts of the tank that are located opposite each other along the larger extension of the tank, and will be placed accordingly in the vertical assembled position of the tank.

The amplifying means preferably takes the form of at least one means for draining the fluid mixture that defines a closed or open volume.

Advantageously, the said draining means is an orifice or a draining duct that is located outside or inside the said tank.

Further, the said draining means may comprise at least one adjustable shutting means. The adjustable shutting means may be a valve, a plug, a diaphragm or a mixing valve.

Advantageously, the device according to the invention may comprise additional ancillary devices on the inside, such as a rake and/or a diaphragm and/or a fan and/or an accelerator.

The mixing device according to the invention may have a cylindrical or rectangular or ovoid or spherical or trapezoidal tank.

The invention will be understood clearly in light of the description below, relating to illustrative examples of this invention that are not limitative in any way, by reference to the drawings enclosed, where:

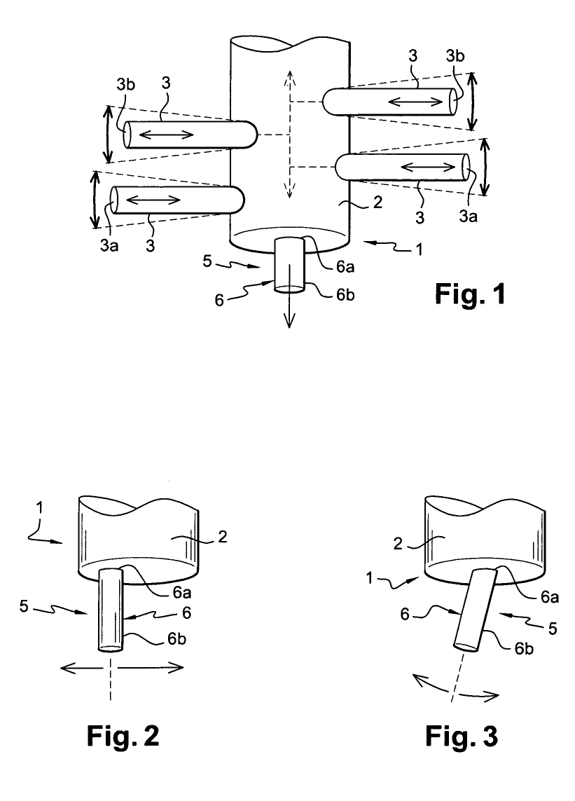

FIG. 1 is a partial front and perspective schematic representation of the device according to the invention;

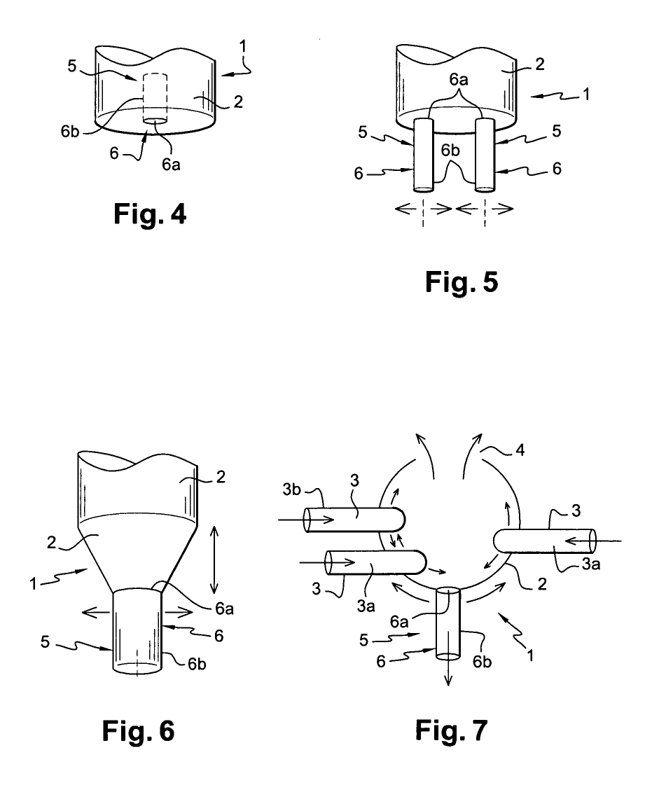

FIGS. 2 to 5 are partial perspective front views of the device according to the invention;

FIG. 6 is a partial perspective front view of another embodiment of the device according to the invention;

FIG. 7 is a schematic representation of another alternative of the device according to the invention.

The device according to the invention relates to a mixing apparatus used to feed air to all the low-pressure systems of an aircraft, for example, while regulating the temperature homogeneity.

FIG. 1 is a schematic representation of the device according to the invention.

A mixing apparatus 1 generally comprises a mixing tank 2, with a central line, provided with inlet and outlet ducts arranged so as to create a swirling movement inside the said tank.

Preferably, the tank 2 of the mixing apparatus according to the invention is provided with flow inlets 3 in its lower part in relation to the central line and flow outlets 4 in its upper part arranged so as to create an upward swirling movement of the fluid inside the said tank in order to ensure an homogenous temperature at the outlet.

In that way, it makes it possible to mix:
at least one inlet duct 3a for hot air flow from an aircraft cabin, and
at least one inlet duct 3b for cold air flow taken from outside the aircraft and then conditioned in respect of pressure and temperature,
in order to obtain outlet ducts 4 with air flows at an homogenous and regulated temperature for cabin air conditioning.

In order to mix the incoming air flows in the best way, it is necessary to create a swirling movement of fluid inside the tank 2, and thus arrange the air flow inlet ducts 3 according to the movement of fluid required inside.

According to a preferred arrangement, the inlet ducts are substantially tangential to the wall of the said tank.

Preferably, the inlet ducts are arranged at an angle that ranges from tangential and perpendicular to the wall of the said tank.

Alternatively, the air flow inlet ducts 3 and outlet ducts 4 may have variable orientations (angle required in relation to the central line of the said tank).

Favourably, the inlet ducts 3 and the outlet ducts 4 are arranged at heights that are variable among themselves (inlet and inlet) and in relation to the others (inlet and outlets).

Preferably, the number, arrangement and geometry of the inlet ducts 3 and outlet ducts 4 are variable.

The inlet ducts 3 and/or the outlet ducts 4 may be symmetrical to each other in relation to the central line of the said tank 2.

Preferably, the tank 2 has the same number of air flow inlet ducts 3 on either side and for hot and cold air flows.

Alternatively, there may be an odd number of inlet ducts 3 on one side of the tank 2 and an even number on the other.

According to another arrangement, the said tank 2 may have hot air inlet ducts 3a on only one side, whilst the cold air inlet ducts 3b are placed on the other side.

The sections and diameters of the orifices and inlet ducts 3 and outlet ducts 4 are also variable and depend on the required output of the said mixing apparatus 1.

All the inlet ducts 3 and outlet ducts 4 may be shut or regulated by at least one adjustable shutting means (not represented but of a type known in itself).

The said tank 2 is preferably cylindrical, but may also be rectangular, ovoid, spherical, trapezoidal, etc.

The fluid flow regime generally obtained is of the left-hand helical symmetrical type in relation to the central line of the said tank.

It is known that the quality of temperature mixing depends on the direction and/or geometric characteristics of the inlet ducts 3 of the mixing apparatus according to the invention, and also the outlet ducts 4 of the mixing apparatus 1.

It has been demonstrated that the quality of temperature mixing achieved also depends on the interaction between the main swirl formed inside the tank 2 of the mixing apparatus 1 and the stationary swirling structures located near the internal walls of the said mixing apparatus.

The understanding of the flows internal to the mixing apparatus makes it possible to optimise the size of such a device, with or without geometrical modifications to the air flow inlet and outlet ducts (size and number of air flow inlet and outlet ducts).

The device according to the invention thus comprises a tank 2 provided with at least one means 5 for modifying the interactions between the main swirl and the stationary swirling structures located near the internal walls of the said tank.

In other words, the said at least one means 5 for modifying the interactions may also be called at least one fluid mixing optimisation or amplification or acceleration means, aimed at reducing the size of the said tank and thus of the said mixing apparatus 1.

FIGS. 2 to 5 are partial perspective front views of the device according to the invention.

The said at least one means 5 for amplifying fluid mixing takes the form of at least one draining means 6 that is suitably located.

The said at least one draining means 6 comprises a draining orifice 6a and/or duct 6b placed on the lower part of the tank 2 in relation to its central line.

In other terms, the said at least one draining means 6 takes the form of a lower orifice 6a opening from the bottom of the said tank 2, with or without a duct 6b towards the outside or inside of the tank 2, which may be shut or otherwise by at least one adjustable shutting means (not represented but of a type known in itself).

According to another alternative, the said tank 2 may comprise a draining means 6 that takes the form of an orifice 6a opening onto a duct with an end or part of its length inside the said tank and the other part outside it.

The said at least one draining means 6 makes it possible to drain or recycle or even supply air flow from another ancillary air distribution network or even an unconnected duct 6b, i.e. to the atmospheric pressure, for instance.

Advantageously, the said at least one draining means 6 is at least an additional means for communicating with the outside/inside of the said tank, and/or a discontinuity element located on the surface or lower part of the said tank 2, which makes it possible to drain the inside of the tank.

More precisely, the movement of fluid inside the tank 2 is a helical swirling movement. The main swirl, which generally has a helical shape, may rotate periodically. The swirl structures near the wall are usually stationary.

This configuration of a mixing apparatus according to the invention, comprising at least one draining means 6, takes the form of an element for communicating with the outside/inside that defines an open or closed volume on the lower part of the said tank 2, thus allowing the creation of a larger and more intense main swirl, which enables it to interact more with the stationary swirl structures located near the internal walls of the tank.

Further, this device makes it possible to favourably increase the fluid speeds near the walls.

Because of the size and intensity of the main swirl created and the optimum draining output achieved thanks to the at least one draining means 6, temperature exchange is optimised so as to allow a reduction in the size and volume of the tank 2.

The mixing apparatus according to the invention makes it possible to adapt it to the constraints of aerospace and/or land transport, particularly in respect of size.

The orifice 6a and the duct 6b are arranged variably, that is they may be located on the entire surface of the bottom of the tank 2. In other words, the said at least one draining means 6 may be displaced on the bottom of the tank 2.

Advantageously, the said at least one draining means 6 may also have a variable direction in relation to the central line of the tank 2.

FIG. 5 illustrates an example of a tank with two draining means 6.

The two draining means 6 may be placed at a variable distance from each other on the surface of the lower part of the said tank 2.

Advantageously, the phenomenon produced inside the tank 2 according to the invention makes it possible to reduce the noise of air flow mixing, because the device according to the invention allows a reduction of the production of sound power.

FIG. 6 is a partial perspective front view of another embodiment of the device according to the invention.

The draining orifice 6a and the draining duct 6b have a given diameter and section, which may be variable depending on the aircraft and/or land transport vehicle to be equipped and the load at the outlet of the mixing apparatus that is required by the head loss of the various systems connected to the mixing tank.

Favourably, the said duct 6b can have any dimension and any geometrical shape possible.

As illustrated in FIG. 6, the lower base of the tank 2 of the mixing apparatus according to the invention may have a certain geometrical shape that is suited to the future position of the said mixing apparatus 1. The diameter and section of the said orifice 6a and the said duct 6b remain variable and depend on the future working and arrangement of the said mixing apparatus 1.

Preferably, the said at least one draining means 6 has at least one adjustable shutting means such as a valve or plug or any other means of a type known in itself.

Advantageously, the said at least one valve may also be a mixing valve or diaphragm or tap or any other flow adjustment and shutting and opening means of a type known in itself.

Alternatively, the said at least one draining means 6 may comprise a cap or any other shutting means of a type known in itself.

The said at least one draining means 6 makes it possible to reduce the height of the said device according to the invention by at least 30% in relation to the height of a mixing apparatus of a known type and thus also considerably reduce its size.

Further, the device according to the invention including the said at least one draining means 6 makes it possible to reduce the head loss, which leads to energy savings between the inlet and outlet sections of the said tank, and therefore lower supply power.

Advantageously, the temperature of the outlet flows obtained is homogenous.

FIG. 7 is schematic representation of another alternative of the device according to the invention.

As an illustrative example, FIG. 7 is a mixing apparatus 1, including an ovoid tank 2 and an odd number of inlet ducts 3.

Additional ancillary and connected devices may be provided in the tank 2, such as for instance at least one turbulence diaphragm or rake (not represented but of a type known in itself.

Advantageously, the configuration of the mixing apparatus according to the invention with suitably positioned internal ancillary and/or connected devices makes it possible to optimise the size of the said mixing apparatus even further.

Alternatively, at least one fan and/or fluid accelerator may be placed at the inlet ducts 3 and/or near the said draining means 6 and/or near the internal walls of the tank 2 thereby increasing the fluid speed.

The device according to the invention thus enables the conditioning of the air in the aircraft, for instance, while effectively reducing its dimensions and also its mass and the known drawbacks of the prior art of low-pressure air distribution systems in respect of air, temperature, acoustic and power performance.

Alternatively, the device according to the invention can mix another type of fluid and be used for example in the land transport industry (internal combustion engine) or physics, particularly for heat exchangers.

1: An air flow mixing device (1) made up of a tank (2), having a central line and provided with inlet ducts (3) and outlet ducts (4), arranged so as to create an upward swirling movement of the said fluid inside the said tank in order to ensure homogenous temperature at the outlet, characterised in that the said tank comprises at least one means (5) for amplifying fluid mixing.

2: A mixing device (1) according to claim 1, characterised in that the said at least one amplifying means (5) is arranged on the lower part of the tank (2).

3: A mixing device (1) according to claim 1, characterised in that the said at least one amplifying means (5) takes the form of at least one means (6) to drain the fluid mixture defining an open or closed volume.

4: A mixing device (1) according to claim 3, characterised in that the said draining means (6) is an orifice (6a).

5: A mixing device (1) according to claim 3, characterised in that the said draining means (6) is a draining duct (6b) located on the outside of the said tank.

6: A mixing device (1) according to claim 5, characterised in that the said draining means (6) is a draining duct (6b) located on the inside of the said tank.

7: A mixing device (1) according to claim 3, characterised in that the said draining means (6) comprises at least one adjustable shutting means.

8: A mixing device (1) according to claim 7, characterised in that the said at least one adjustable shutting means is a valve, a plug, a diaphragm or a mixing valve.

9: A mixing device (1) according to claim 1, characterised in that the said tank (2) is cylindrical or rectangular or ovoid or spherical or trapezoidal.

10: A mixing device (1) according to claim 1, characterised in that the said tank (2) comprises additional ancillary devices on the inside, such as a rake or a diaphragm or a fan or an accelerator.

11: A mixing device according to claim 1, characterised in that it is used in aeronautics, particularly for aircraft air conditioning, or in land transport, particularly for engines or in physics, particularly for heat exchangers.
